(19) United States
(12) Patent Application Publication
(10) Pub. No.: US 2017/0249080 A1
(43) Pub. Date: Aug. 31, 2017

(54) SOLID-STATE STORAGE DEVICE WITH PROGRAMMABLE PHYSICAL STORAGE ACCESS

(71) Applicant: ITU Business Development A/S, Copenhagen S (DK)

(72) Inventors: Philippe Bonnet, Copenhagen S (DK); Matias Bjørling, Copenhagen S (DK); Jesper Madsen, Copenhagen S (DK); Javier Gonzáles, Copenhagen S (DK)

(21) Appl. No.: 15/056,305

(22) Filed: Feb. 29, 2016

(51) Int. Cl. G06F 3/06; G06F 12/10; G06F 12/02

(52) U.S. Cl. CPC G06F 3/061; G06F 12/0246; G06F 12/1009; G06F 3/0688; G06F 3/0655; G06F 2212/7201; G06F 2212/2022

(57) ABSTRACT

Embodiments of the present invention includes a method of operating a solid-state storage device, comprising a storage device controller in the storage device receiving a set of one or more rules, each rule comprising (i) one or more request conditions to be evaluated for a storage device action request received from a host computer, and (ii) one or more request actions to be performed on a physical address space of a non-volatile storage unit in the solid-state storage device in case the one or more request conditions are fulfilled; the method further comprises: the storage device receiving a storage device action request, and the storage device evaluating a first rule of the one or more rules by determining if the received request fulfills request conditions comprised in the first rule, and in the affirmative the storage device performing request actions comprised in the first rule. A corresponding solid-state storage device is also provided.

### BACKGROUND OF THE INVENTION

Current state-of-the-art solid-state storage drives (SSDs) can perform millions of I/O operations per second, and it is expected that future SSDs will scale as the industry continues to make advancements in integration and memory technologies. At the same time, SSDs need to make decisions to map torrents of I/O requests to underlying non-volatile memory chips. This is at odds with the low latency requirements of data-intensive applications. In the networking area, a similar phenomenon has taken place. As switches evolved from Gigabit/s to 10-Gigabit/s, it became clear that giving system designers the flexibility to route data packets is at odds with low latency. Network designers needed a way to control how data flows without being in the path of data itself. As a result, software-defined networking was born. Today, OpenFlow has emerged as the de facto standard. Unlike a traditional switch, which performs packet forwarding and routing decisions on the same device, OpenFlow separates the data plane from the control plane by moving routing decisions to a higher-level device, called the controller. OpenFlow uses an abstraction called a flow to bridge the data plane and control plane. Every OpenFlow switch contains a flow table, which controls how packets are routed. OpenFlow controllers install entries into the table, and can inspect the state of flows through counters and messages from the switch.

### SUMMARY OF THE INVENTION

The inventors analyzed the OpenFlow concepts in another context. Though not obvious to the person skilled in the art, the inventors had a sense that it would be prudent to analyze OpenFlow concepts in more detail in relation to SSDs, believing that certain considerations in OpenFlow could have parallels to data-placement problems in SSDs. They realized that the traditional Flash Translation Layer (FTL) could be seen as being somewhat similar to a traditional switch: a black box that performs both data placement and the placement decisions on the same device.

In other respects, network switches and SSDs are vastly different and require fundamentally different considerations, as a person skilled in networks and a person skilled in SSD devices will readily realize.

Traditionally, a flash translation layer (FTL) has been provided by SSD manufacturers in order to optimize data placement and minimize defects on storage units such as NAND flash chips and NOR flash chips. The FTL cannot be circumvented, but given that it seeks to optimize data placement and minimize defects, this may seem desirable. Wear leveling methods, for instance, are constantly being improved to increase in storage unit longevity, and it would seem ideal to use a fixed FTL, since the “latest in FTL schemes” is necessarily considered “state of the art” by consumers.

For a number of applications, the FTL, access speeds are substantially lower than they could optimally be, despite attempts to reduce latency. As the number of accessible SSDs on a storage system increases, the latency increases even further.

A first aspect of the invention provides a method of operating a solid-state storage device. Embodiments of the method comprise:
a storage device controller in the storage device receiving a set of one or more rules, each rule comprising:
i) one or more request conditions to be evaluated for a storage device action request received from a host computer, and
ii) one or more request actions to be performed on a physical address space of a non-volatile storage unit in the solid-state storage device in case the one or more request conditions are fulfilled,
the storage device receiving a storage device action request, and
the storage device evaluating a first rule of the one or more rules by determining if the received request fulfills all request conditions comprised in the first rule, and in the affirmative the storage device performing all request actions comprised in the first rule.

Some embodiments further comprise performing, for each remaining rule, if any, in the set of rules, steps of:
evaluating the rule by determining if the received request fulfills all request conditions comprised in the rule, and in the affirmative the storage device performing all request actions comprised in the rule, whereby all rules in the set of rules have been evaluated in a sequence.

In some embodiments, the sequence in which the set of rules is evaluated takes into account a priority parameter comprised in each of the one or more rules.

In some embodiments, the request is received from the host computer by direct memory access to a digital memory device in the host computer. This bypasses the host computer and allows application on the host computer to more efficiently provide requests to the storage device.

In some embodiments, the storage device comprises at least a first and a second storage unit, each having a corresponding physical address space, and the storage device controller is configured to:
store a first and a second set of rules,
apply the first set of rules within the first storage unit physical address space, and
apply the second set of rules within the second storage unit physical address space.

Some embodiments further comprise:
an application on the host computer providing a request for a set of rules to be implemented in the storage device,
providing the set of rules to the storage device in response to the application providing the request.

In some embodiments, the set of rules is provided by a kernel module in the host computer.

In some embodiments, the storage device action request is a data write request or a data read request.

A second aspect of the invention provides a solid-state storage device. Embodiments of the storage device comprise:
a data interface connectable to a host computer, the data interface supporting data communication between the storage device and the host,
a set of one or more digital non-volatile storage units configured to store data communicated via the data interface,
a storage device controller connected to the data interface and configured to receive:
i) a write request and a data payload and in response retrievably store at least a part of the received payload in one or more of the storage units,
ii) a read request for data previously retrievably stored in one or more of the storage units, and in response retrieve said data,

and the storage controller is configured to:
receive a set of one or more rules, each rule comprising:
i) one or more request conditions to be evaluated for a storage device action request received from a host computer, and
ii) one or more request actions to be performed on a physical address space of one or more of the storage units in case the one or more request conditions are all fulfilled,
receive a storage device action request, and
evaluate a first rule of the one or more rules by determining if the received request fulfills all request conditions comprised in the first rule, and in the affirmative the storage device performing all request actions comprised in the first rule.

In some embodiments of the storage device, the storage controller is furthermore configured to perform, for each remaining rule, if any, in the set of rules, steps of:
evaluating the rule by determining if the received request fulfills all request conditions comprised in the rule, and in the affirmative the storage device performing all request actions comprised in the rule, whereby all rules in the set of rules have been evaluated in a sequence.

In some embodiments of the storage device, the sequence in which the set of rules is evaluated takes into account a priority parameter explicitly or implicitly comprised in the one or more rules.

In some embodiments of the storage device, the storage controller is configured for direct memory access to random access memory in a host computer, when connected.

Some embodiments of the storage device further comprise a controller memory connected to the storage device controller to allow the main controller to retrievably store data.

In some embodiments, the controller memory comprises a random access memory unit. In some embodiments, the random access memory unit comprises a static random access memory (SRAM) chip. In some embodiments, the random access memory unit comprises a dynamic random access memory (DRAM) chip.

In some embodiments, the controller memory further comprises a solid-state memory unit.

In some embodiments, the solid-state memory unit comprises a negative-AND (NAND) flash chip.

In some embodiments, at least one of the storage units is a NAND flash chip.

A third aspect of the invention provides a digital controller. Embodiments of the digital controller are configured to:
receive a set of one or more rules, each rule comprising:
i) one or more request conditions to be evaluated for a storage device action request received from a host computer, and
ii) one or more request actions to be performed on a physical address space of one or more non-volatile storage units in case the one or more request conditions are fulfilled,
receive a storage device action request, and evaluate a first rule of the one or more rules by determining if the received request fulfills all request conditions comprised in the first rule, and in the affirmative the storage device performing all request actions comprised in the first rule.

In embodiments of the present invention, placement decision logic is placed into a controller in the storage device, while the storage device's ability to do fast and efficient data placement is maintained.

In some embodiments, the interface may communicate on a PCIe bus with a suitable protocol, for instance NVMe.

### BRIEF DESCRIPTION OF THE DRAWINGS

FIG. 1 illustrates a solid-state storage device in accordance with an embodiment of the invention, and a host computer connectable to the storage device.

FIG. 2 illustrates a prior-art solid-state storage device.

FIG. 3 schematically illustrates rules for use with embodiments of the present invention.

FIG. 4 illustrates a method in accordance with an embodiment of the invention.

FIG. 5 illustrates embodiments of the present invention from a different perspective.

### DETAILED DESCRIPTION OF SELECTED EMBODIMENTS

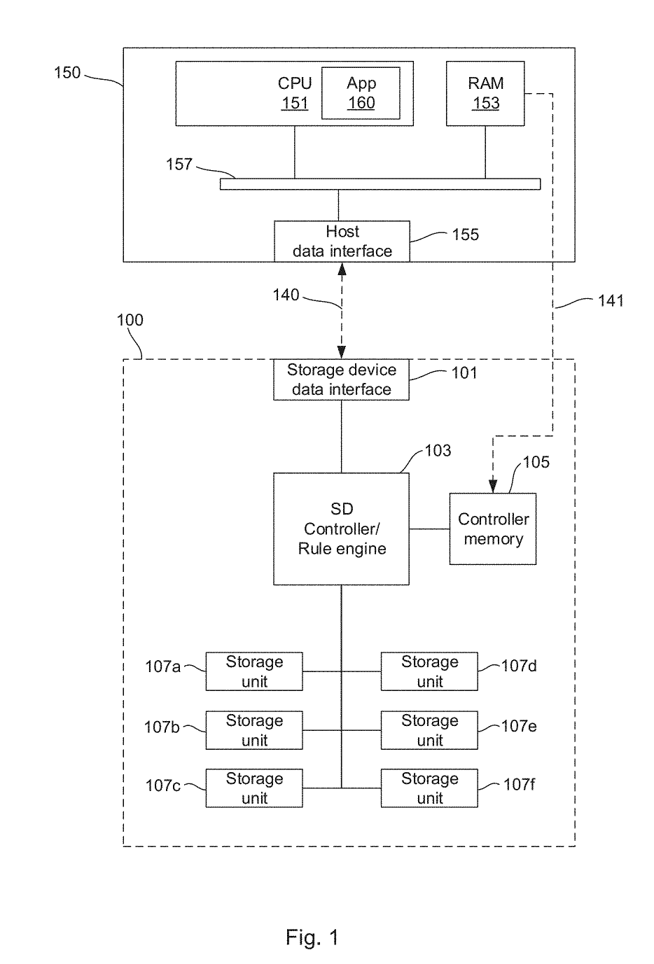

FIG. 1. illustrates a storage device 100 in accordance with an embodiment of the invention. It comprises a data interface 101, a storage device (SD) controller 103, a storage device (SD) controller memory 105, and a set of storage units 107a-107f. The data interface 101 is used for connecting the storage device 100 to a host computer, whereby the storage controller 103 can exchange data with the host. A controller memory 105 allows the storage controller 103 to store data temporarily or permanently.

Data is typically transferred from the host to the storage device in order for the data to be stored in a non-volatile manner in the storage device. In prior art storage devices, data to be stored in a storage device is transferred from the host to the storage device, and a flash translation layer arranges the storing of the data by maintaining a map that connects physical addresses in the storage units to logical addresses that the host can use. Embodiments of the present invention comprise memory units with physical address spaces that are directly accessible from the host. The host provides a set of one or more rules that the storage controller uses in order to store and retrieve data from the storage units.

The storage device 100 in FIG. 1 is configured to connect to a host 150, such as a personal computer or server computer. The storage device 100 and host 150 can be in data communication via a communication line 140. Simplified, the host 150 comprises a central processing unit (CPU) 151, random access memory (RAM) 153, a host data interface 155, and a communication bus 157. The communication bus 157 enables data communication between the CPU 151, RAM 153, and host data interface 155.

When data is transferred between the host 150 and the storage device 100, this may be performed via a direct transfer from the RAM 153 in the host to the controller memory 105 in the storage device 100. Preferably, this takes place without interference of the host CPU 151 by use of direct memory access (DMA), such as by remote direct memory access (RDMA). This is illustrated schematically with dashed line 141 in FIG. 1. The physical transfer takes place via the connection 140 between the host data interface 155 and the storage device data interface 101.

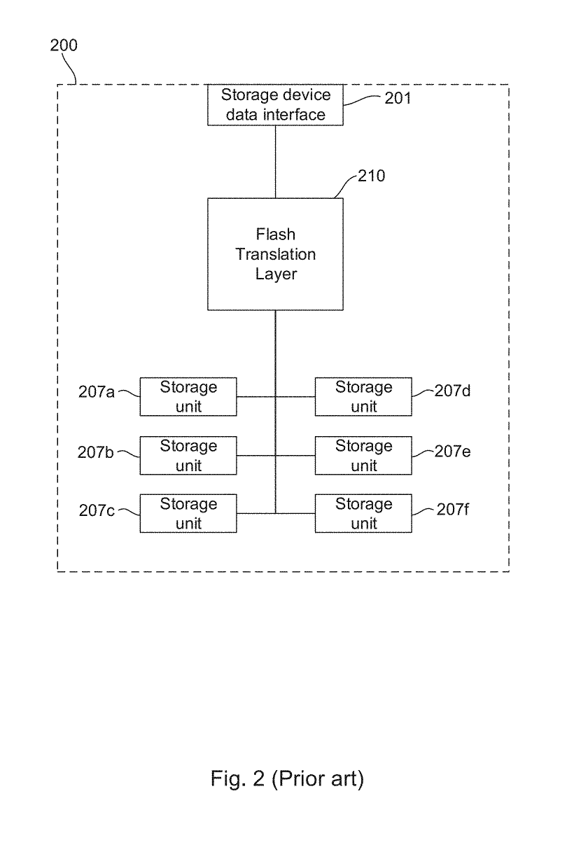

FIG. 2 illustrates a prior art SSD. Overall, it has many of the same features, such as a data interface 201 and storage units 207a-207f, as well as a controller 210 for handling communication of requests for data to and from the storage units 207a-207f. However, the controller 210 in prior art devices is hard-coded with translation rules that control how the data is written to the storage units, and how the data are moved between physical addresses in the storage units, as well as how garbage collection is performed in the storage units in order to free invalid storage space (such as pages and/or blocks in a NAND). In particular, the controller 210 provides a pre-defined method for translating logical addresses usable by the host 150, to physical addresses usable by the controller 210 for accessing the storage units. In other words, it is not possible to access the physical address directly from the host. Furthermore, it is not possible to control access to separate storage units from outside the storage device.

Embodiments of the present invention allow applications 160 running on a host 150 to dynamically provide and change or delete rules 120 that suit the application's needs with respect to storage and retrieval of data on the storage device 100.

The storage device maintains a mapping table in order to enable consistent writing and reading to and from the storage units. The mapping table may for instance comprise associations between the logical address of data and the physical address in the storage device at which the data is stored. The mapping table is configured to reflect the addressability of the storage units and the need for a specific use case. In NAND flash chips, data is written and read page by page, and data is erased in blocks.

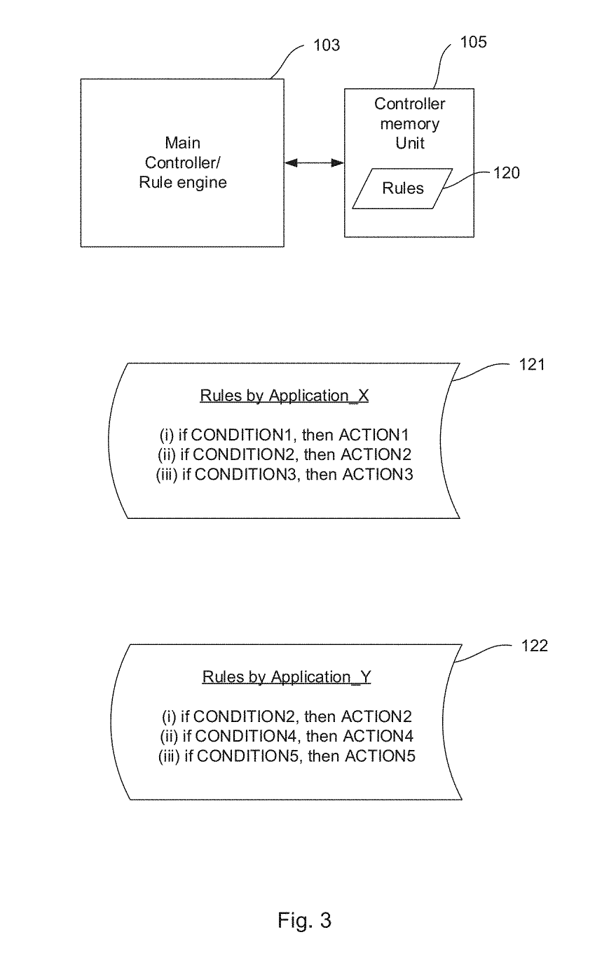

FIG. 3 illustrates schematically an embodiment where rules are stored in a controller memory unit 105. The set of rules 121 are directed to an application “X” and comprises conditions CONDITION1, CONDITION3, and CONDITION3. If CONDITION1 is satisfied for a request, then action ACTION1 is performed. If CONDITION2 is satisfied, action ACTION2 is performed. If CONDITION3 is satisfied, action ACTION3 is performed. Corresponding state changes are also performed, but are not shown as this is merely to illustrate the principle behind rules, namely that if a request fulfills a certain condition (or set of conditions), an action (or set of actions) is taken.

The rules 122 apply to an application “Y”. Rule 122 share a rule with rule set 121, namely the CONDITION2-ACTION2 rule. If CONDITION2 is satisfied, action ACTION2 is performed. If CONDITION4 is satisfied, action ACTION4 is performed.

If CONDITION5 is satisfied, action ACTION5 is performed. There can be any number of conditions, state changes and actions.

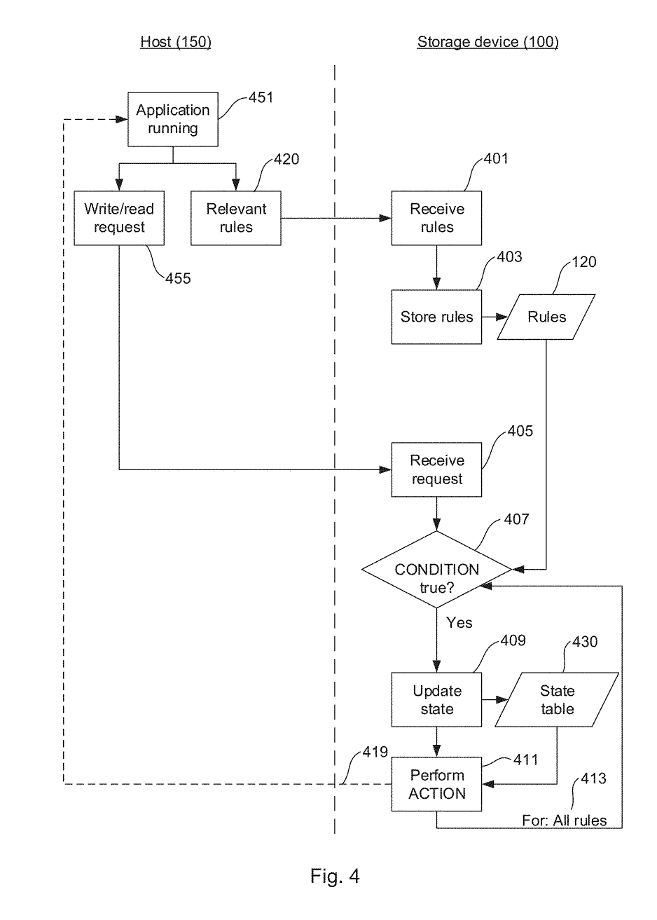

FIG. 4 illustrates a method in accordance with an embodiment of the invention. The method performed applies to a storage device 100, but exemplary steps performed in a host 150 are also shown in FIG. 4 and described here for context.

An application 451 is running on a host computer 150. Different applications have different requirements regarding reading and writing of data. Relevant rule/rules 420 can be provided by the application 451 to the storage device 100 at a convenient time. In step 401, the storage device 100 receives such a rule or rules 420. The rules 420 are stored in the storage device in step 403. The storage device 100 has a storage for storing the rules 120. The rules may be stored in RAM and/or in a non-volatile storage device.

When the host application 451 needs access to data on the storage device, it sends a request, in step 455, which is received by the storage device in step 405. A request is an operation on the logical address space, for instance a request to read at a given address or write at a given address with a payload. As another example, it could also be a request to scan a range of addresses or filter a range of addresses with a condition.

A rule describes how requests shall be processed. A rule comprises one or more conditions and one or more actions, and optionally also a state change. A state change may affect the internal state of the storage device. For example, a state change may update a mapping table or an internal counter. Examples of other internal state information includes:
a table representing the hierarchy of blocks, identified by their physical block addresses (sometimes called a global mapping directory, GMD), a free block list (FB): a list of blocks that are free (or recently erased),
a current block list (CB): a list of blocks used for writing pages, identified by their physical block addresses,
a page validity bitmap (PVB): a bitmap associating a bit (valid/invalid) to each physical page address, and
a bad block list (BBL): a list of damaged blocks identified by their physical block addresses.

The mapping table is updated for instance when a new page is written in response to a request for writing data is received from the application 451. The state is comprised in storage in the storage device, illustrated by a state “table” 430 in FIG. 4. State information can be stored in many ways, which is well known to the person skilled in the art.

In relation to the updating of the state table 430, any required action(s), i.e. operation on physical address space(s) of one or more storage units 207a-207f in the solid-state storage device 100 (see FIG. 1), is/are performed.

The method path 413 in FIG. 4 illustrates that the conditions, state changes and actions are evaluated and performed for all relevant rules 120.

The storage device may, as indicated by dashed line 419, provide a signal back to the host to communicate information regarding the application of the set of the rules.

As an example, a rule, RULE1, may look like this:

| Condition | channel.appid == APP₀ and header.write |
|---|---|
| State change | MAP APP₀, header.LBA = NEXT_ADDR |
| Action | WRITE header.addr = NEXT_ADDR; INSERT TO_LUN |
| Priority | 0 |

The rule may be interpreted as follows.

IF (condition):
the request is a write at address LBA

THEN (state change):
get the PBA for the next free page on the CB list; if that block is full then pop the next block from the free block list and insert it in the current block list
update the mapping table entry for LBA to PBA

AND THEN (action):
write the payload at the address PBA.

As another example, a RULE2 looks as follows:

| Condition | header.write |
|---|---|
| State change | PERFORM GC GREEDY ALL APP |
| Action | WRITE header.block = VICTIM_BLOCK; |
| | INSERT VALID TO ANY_LUN |
| Priority | 0 |

The rule may be interpreted as follows.

IF (condition):
The request is a write

THEN (state change):
Pick a victim block based on the state information (PVB)
Pick a new block from the free list (FB)

AND THEN:
For each valid page in the victim block:
   Read page from victim block
   Write page onto new block
Erase victim block

As a third example, RULE3 looks as follows:

| Condition | channel.appid == APP₀ and header.read |
|---|---|
| State change | |
| Action | WRITE header.addr = MAP APP₀, header.LBA; |
| | INSERT ANY_LUN |
| Priority | 1 |

The rule may be interpreted as follows.

IF (condition):
The request is a read at address LBA

THEN (state change):
Read PBA associated to LBA in mapping table

AND THEN:
Read the payload at address PBA and return it.

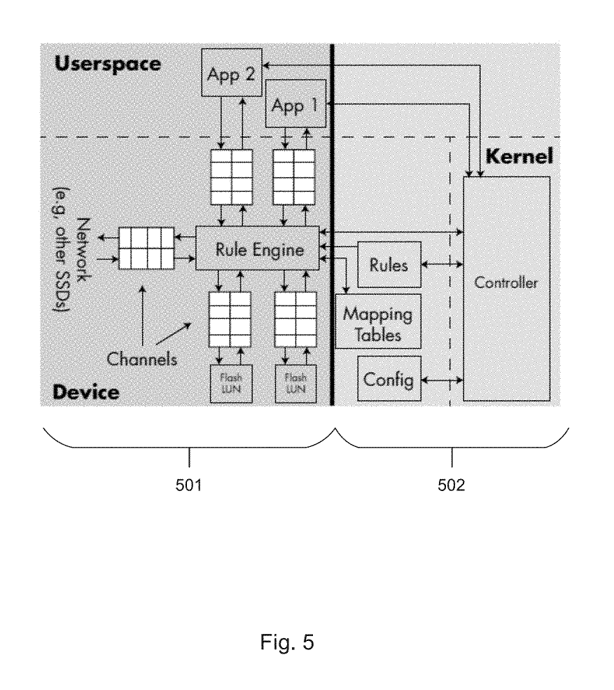

FIG. 5 illustrates embodiments of the invention from another perspective. Embodiments of the invention separate the data from the control. Part 501 in FIG. represent a data plane, and part 502 represents a control plane (see also PETER, S., LI, J., ZHANG, I., PORTS, D. R. K., WOOS, D., KRISHNAMURTHY, ANDERSON, T., AND ROSCOE, T. Arrakis: The operating system is the control plane. In 11th USENIX Symposium on Operating Systems Design and Implementation (OSDI 14) (Broomfield, Colo., Oct. 2014), USENIX Association, pp. 1-16.) The applications App 1 and App 2 may communicate directly with the device controller (“Rule Engine”) via for instance queues of requests in channels. Each channel may have a submission queue for requests and a completion queue for responses for communicating data between the applications, such as App 1 and App 2, and the Rule Engine.

Applications communicate directly to the storage device by sending requests through a channel mapped into user space, bypassing the operating system kernel. Flash channels are abstracted as channels, and there may be several “virtual” channels used by internal processes for garbage collection and wear levelling. In addition, channels may map to remote storage devices.

To move data between channels, the SSD may also apply sets of rules to incoming traffic on each queue. For example, the device could drop a request, rewrite request headers or place the input on another channel.

The controller may also dictate whether state changes and actions are executed atomically or not. A rule priority may be used to determine which rule is evaluated first, in the event that multiple conditions match a given input. If a rule does not exist for some input, the device may send the input to the controller and request a new rule.

A set of rules may be associated to a portion of the physical address space of the storage device. Put differently, the physical address space can be partitioned into a collection of address spaces, and each may be managed by a set of rules. Preferably, the set of rules is consistent, i.e. it (i) respects the constraints introduced by the flash, such as NAND flash, and (ii) respects the integrity of the SSD state (even in the face of bugs or power failures).

In some embodiments, a storage device action request is posted on an input channel, and the rule engine dequeues requests from the input channels, selects one or several rules to apply and apply them. Each rule consists of a transformation of the storage device state, and operations on the physical address space are queued on corresponding output channels. Each output channel is associated to a range of physical block addresses (and the physical page addresses they contain). Put differently, each output channel has an id. Given an operation on a physical block address or physical page address, the rule engine selects the channel id that it is associated with.

The controller may for instance be provided as a Linux kernel module, for instance using the LightNVM framework (BJØRLING, M., MADSEN, J., BONNET, P., ZUCK, A., BANDIC, Z., and WANG, Q.: “Lightnvm: Lightning fast evaluation platform for non-volatile memories”), which can be used to retrieve device configuration and to implement a rule-based target. Userspace applications request channels from the kernel using a library. During channel setup, applications may for instance request a set of rules to be installed, or choose from a number of template rules provided by the kernel. These rules may tradeoff parameters such as performance, predictability and media life depending on application workload and requirements.

The kernel may furthermore inspects rules and apply any transformations that are necessary to enforce permissions and applies any global policies such as wear leveling and garbage collection. Subsequent requests from the application are then sent directly to the device via the allocated channel without intervention of the kernel.

1. A method of operating a solid-state storage device, comprising
a storage device controller in the storage device receiving a set of one or more rules, each rule comprising:
i) one or more request conditions to be evaluated for a storage device action request received from a host computer, and
ii) one or more request actions to be performed on a physical address space of a non-volatile storage unit in the solid-state storage device in case the one or more request conditions are fulfilled,
the storage device receiving a storage device action request, and
the storage device evaluating a first rule of the one or more rules by determining if the received request fulfills all request conditions comprised in the first rule, and in the affirmative the storage device performing all request actions comprised in the first rule.

2. The method in accordance with 1, further comprising performing, for each remaining rule, if any, in the set of rules:
evaluating the rule by determining if the received request fulfills all request conditions comprised in the rule, and in the affirmative the storage device performing all request actions comprised in the rule, whereby all rules in the set of rules have been evaluated in a sequence.

3. The method in accordance with claim 2, wherein the sequence in which the set of rules is evaluated takes into account a priority parameter comprised in each of the one or more rules.

4. The method in accordance with claim 2, wherein the request is received from the host computer by direct memory access to a digital memory device in the host computer.

5. The method in accordance with claim 2, wherein the storage device comprises at least a first and a second storage unit, each having a corresponding physical address space, and the storage device controller configured to:
store a first and a second set of rules,
apply the first set of rules within the first storage unit physical address space, and
apply the second set of rules within the second storage unit physical address space.

6. The method in accordance with claim 2, further comprising:
an application on the host computer providing a request for a set of rules to be implemented in the storage device, and
providing the set of rules to the storage device in response to the application providing the request.

7. The method in accordance with claim 6, wherein the set of rules is provided by a kernel module in the host computer.

8. The method in accordance with claim 1, wherein the storage device action request is a data write request or a data read request.

9. A solid-state storage device comprising:
a data interface connectable to a host computer, the data interface supporting data communication between the storage device and the host,
a set of one or more digital non-volatile storage units configured to store data communicated via the data interface, and
a storage device controller connected to the data interface and configured to receive:
i) a write request and a data payload and in response retrievably store at least a part of the received payload in one or more of the storage units, and
ii) a read request for data previously retrievably stored in one or more of the storage units, and in response retrieve said data,
wherein the storage controller is configured to:
receive a set of one or more rules, each rule comprising:
i) one or more request conditions to be evaluated for a storage device action request received from a host computer, and
ii) one or more request actions to be performed on a physical address space of one or more of the storage units in case the one or more request conditions are all fulfilled,
receive a storage device action request, and
evaluate a first rule of the one or more rules by determining if the received request fulfills all request conditions comprised in the first rule, and in the affirmative the storage device performing all request actions comprised in the first rule.

10. The solid-state storage device in accordance with claim 9, wherein the storage controller is further configured to perform, for each remaining rule, if any, in the set of rules:
evaluating the rule by determining if the received request fulfills all request conditions comprised in the rule, and in the affirmative the storage device performing all request actions comprised in the rule, whereby all rules in the set of rules have been evaluated in a sequence.

11. The solid-state storage device in accordance with claim 10, wherein the sequence in which the set of rules is evaluated takes into account a priority parameter explicitly or implicitly comprised in the one or more rules.

12. The solid-state storage device in accordance with claim 9, wherein the storage controller is configured for direct memory access to random access memory in a host computer, when connected.

13. The solid-state storage device in accordance with claim 9, further comprising a controller memory connected to the storage device controller to allow the main controller to retrievably store data.

14. The solid-state storage device in accordance with claim 13, wherein the controller memory comprises a random access memory unit.

15. The solid-state storage device in accordance with claim 14, wherein the random access memory unit comprises a static random access memory (SRAM) chip.

16. The solid-state storage device in accordance with claim 14, wherein the random access memory unit comprises a dynamic random access memory (DRAM) chip.

17. The solid-state storage device in accordance with claim 9, wherein the controller memory further comprises a solid-state memory unit.

18. The solid-state storage device in accordance with claim 17, wherein the solid-state memory unit comprises a negative-AND (NAND) flash chip.

19. The solid-state storage device in accordance with claim 9, wherein at least one of the storage units is a NAND flash chip.

20. A digital controller configured to:
receive a set of one or more rules, each rule comprising:
i) one or more request conditions to be evaluated for a storage device action request received from a host computer, and
ii) one or more request actions to be performed on a physical address space of one or more non-volatile storage units in case the one or more request conditions are fulfilled,
receive a storage device action request, and
evaluate a first rule of the one or more rules by determining if the received request fulfills all request conditions comprised in the first rule, and in the affirmative the storage device performing all request actions comprised in the first rule.
